(19) United States
(12) Patent Application Publication
(10) Pub. No.: US 2015/0305302 A1
(43) Pub. Date: Oct. 29, 2015

(54) Method and System for Restraining a Pet while Bathing

(71) Applicant: Gerald Raftopoulos, West Palm Beach, FL (US)

(72) Inventor: Gerald Raftopoulos, West Palm Beach, FL (US)

(21) Appl. No.: 14/261,228

(22) Filed: Apr. 24, 2014

(51) Int. Cl. A01K 13/00; A01K 15/04

(52) U.S. Cl. CPC A01K 13/00; A01K 15/04

(57) ABSTRACT

A system for restraining a pet while washing or for any other reason. A wash bag is made from mesh material that protects and confines the pet. The bag acts effectively to prevent the pet from running away or moving too much while still allowing complete access to the pet for washing. In the top front center of the bag, there is an opening for the pet's head to emerge. The top of the bag has an end-to-end zipper allowing the bag to completely open from the top and back so that the pet can step into it. There are usually two openings on the side of the bag that allow placement of the hands inside the bag for washing. The pet may lie down or stand up without any harm or discomfort. A drawstring can adjust the neck opening to fit the animal's neck size.

### BACKGROUND

1. Field of the Invention

The present invention relates generally to methods of restraining pets and more particularly to a method and system for restraining a pet while bathing the pet.

2. Description of the Prior Art

There are approximately twenty nine million dog owners and thirty seven million cat owners in the U.S. Many of these owners have multiple pets. All pets need bathing. However, bathing a pet like a dog can be an exasperating experience. As soon as the pet feels the water, they generally try to move or escape. Even with pets that like baths, the pet has to be constantly held to keep from moving or leaving. Also furry pets like dogs like to vigorously shake off water, many times all over their owner.

Several prior art methods of restraining a pet are known in the art. Different boxes and ties have been tried as well as canvas bags. In U.S. Pat. Nos. 2,969,767 and 3,547,079, Bassett describes liquid impervious bags for carrying pets. Bassett's bags do not solve the problem of holding the pet while washing it. Baker in U.S. Pat. No. 4,083,328 teaches a portable pet washing tub with a bag cover, while Lee in U.S. Pat. No. 6,688,257 teaches a pet dog washing apparatus. These devices hold and wash the pet; however, they are heavy and complicated using tubs and the like.

None of the above-described methods are easy to use or solve the problem of washing the pet while still restraining it, but allowing the pet to move or sit and even shake. It would be very advantageous to have a method and system for washing a pet where the pet could just be put into a mesh bag that would pass water through to wash, rinse and drain completely, and could fold up compactly when not in use.

### SUMMARY OF THE INVENTION

The present invention relates to a method and system for restraining a pet while washing it (or for any other reason such as veterinary examination, shots, clipping pets nails, or the like.). Generally, the present invention is a special wash bag made from mesh that protects and confines the pet during washing. The present invention acts effectively to prevent the pet from running away or moving too much while still allowing complete access to the pet for washing. A particular embodiment of the invention is a bag made of around 3 mm Nylon™ mesh that resembles a duffel bag. In the top front center of the bag, there is an opening for the pet's head to emerge. The top of the bag has an end-to-end zipper or VELCRO™ that allows the bag to completely open from the top and back so that the pet can step into it. There are usually two openings on the side of the bag that allow placement of the hands inside the bag for washing. The pet may lie down or stand up without any harm or discomfort. The pet may lie down or stand up without any harm or discomfort. A drawstring can adjust the neck opening to fit the animal's neck size. The bag can be made in different sizes for different sized pets.

### DESCRIPTION OF THE FIGURES

Attention is now drawn to illustrations that aid in understanding the features of the present invention:

FIG. 1 shows an embodiment of the invention containing a dog to be washed.

FIG. 2 shows a side view of a version of the bag empty.

FIG. 3 shows schematic rear view of the bag.

FIG. 4 shows a schematic front view of the bag.

Several illustrations and drawings have been presented showing embodiments of the present invention. The scope of the present invention is not limited to what is shown in the figures.

### DETAILED DESCRIPTION OF THE INVENTION

The present invention relates to a system and method for restraining a pet for washing or other purposes. The invention is generally a bag that the pet can step into that can be zipped or tied into a closed configuration around the pet. Embodiments of the invention are fine mesh with side holes to allow insertion of the hands into the bag for washing.

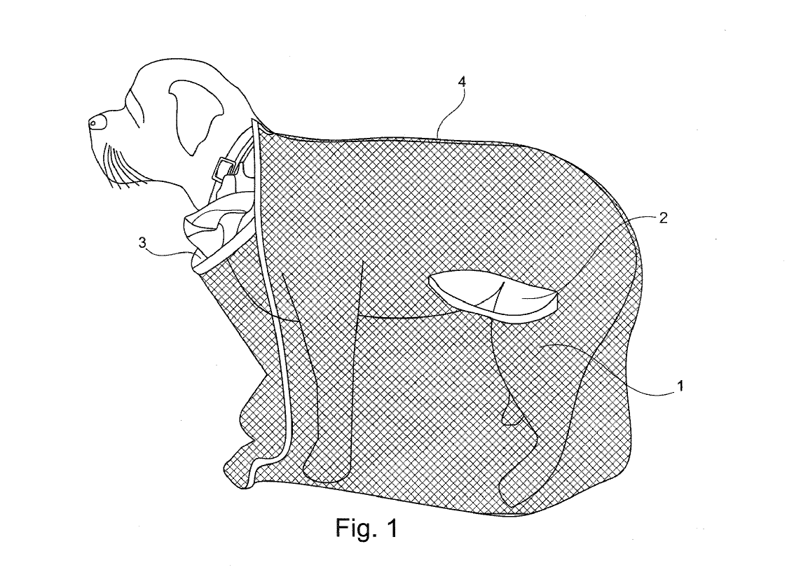

Turning to FIG. 1, an embodiment of the present invention can be seen with a dog inside. A mesh bag 1 of preferred material Nylon of preferred mesh size around 3 mm covers the animal. The bag has a relatively flat mesh floor that allows the pet to stand, sit or lie down. The pet's head protrudes from an opening 3 in the front of the bag. Slit hand openings 2 are located toward the center of each side of the bag. The preferred size of the slit hand openings 2 is around 8 inches long. While these are the preferred openings, any number or size of openings are within the scope of the present invention. Also any permeable water-tolerable material that can pass and drain water may be used. A mesh is particularly useful since it holds very little water but protects against water emerging from the bag if the pet tries to shake. A zipper 4, or other securing mechanism like VELCRO™, runs along the top of the bag 1. The preferred material for the zipper 4 is heavy plastic due to its ease of use and the fact that it is totally water-resistant. In an alternate embodiment, draw strings can be used with a zipper. Any means of securing the edges of the bag together is within the scope of the present invention.

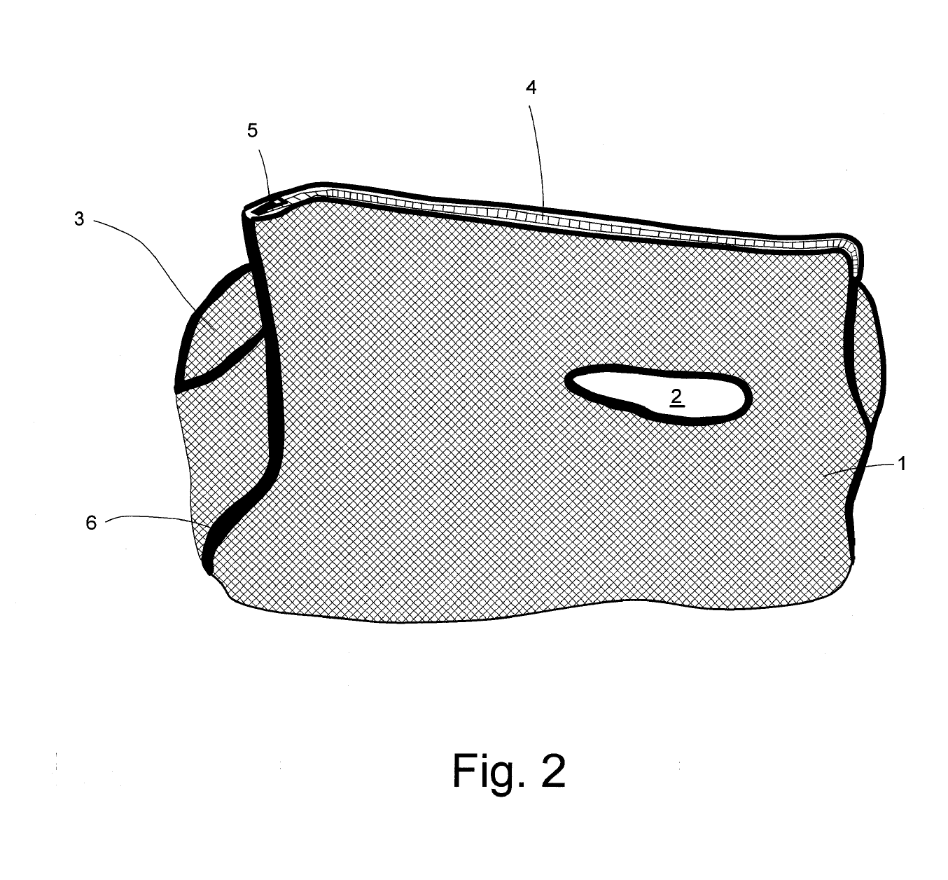

FIG. 2 shows a side view of the embodiment of FIG. 1 without the animal. Parts of the bag 1 are secured together with a zipper 4 with a standard zipper mechanism 5. The bag 1 generally has a flat floor, with a connected front panel 6 to provide an opening 3 for the pet's head. Optional seams 6 can hold the various parts of the bag together. The slit openings 2 can be seen on the sides of the bag.

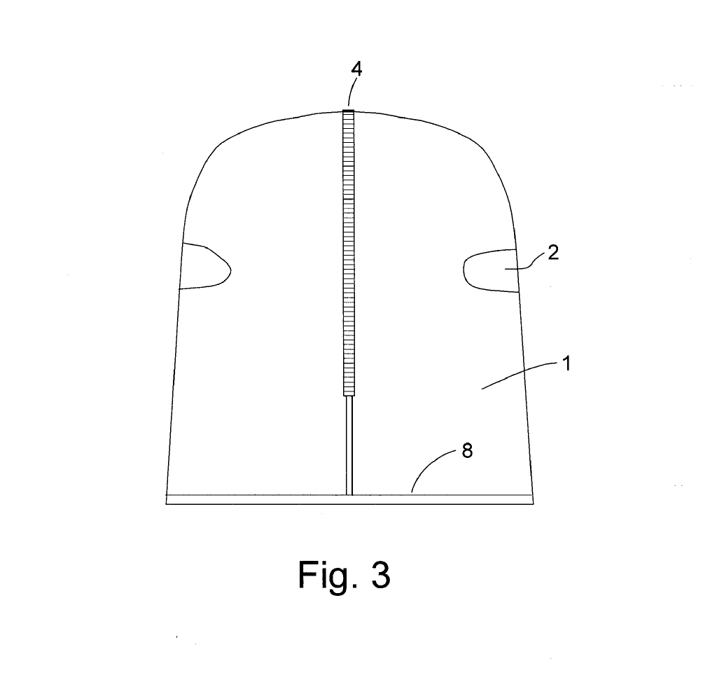

Turning to FIG. 3, a schematic back view of the embodiment can be seen. The bag 1 is sewed or otherwise attached to a flat mesh floor 8. The zipper 4 runs along the top of the bag.

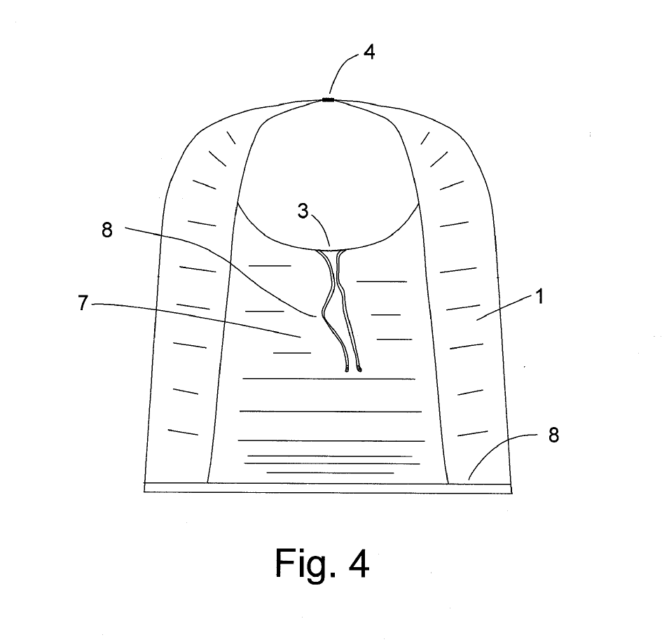

FIG. 4 shows a schematic front view of the embodiment of FIG. 3. A front panel 7 is attached to the sides of the bag and the floor 8. An optional drawstring 8 can be used to tighten the opening around the animal's neck.

To use the invention, the main zipper opened, and drawstring released, and the pet is led or caused to step onto the floor. The sides of the bag are pulled up around the pet with the head emerging from the front. The sides are then zipped together and drawstring is tightened to conform to each individual animal's neck. The pet can now be sprayed with a hose, or washed with a wet cloth. The hands can be inserted into the side slits for soaping and scrubbing. The pet can be finally sprayed to rinse. When the bath is over, the main zipper or drawstring can be released, and the bag falls away from the pet so that the pet can step out.

The embodiments of the present invention can be supplied in many different sizes including tea cup, toy, small, medium, large, extra large and special order. As stated, the preferred material is 3 mm Nylon™ hex-mesh available on the market that is sewed or otherwise configured to form the bag. However, any flexible sheet-like permeable material can be used, including any plastic or polymer mesh. The best materials are those freely pass water through them so that the pet may be rinsed and the water will run out. Any mesh shape can be used on mesh material including hexagon and square meshes. Also, any number or size of side slits or holes can be used with a preferred number being one approximately 8 inch slit on each side a little toward the rear. Alternate embodiments of the invention can use the same mesh and have two openings on each end with drawstrings on both ends to confine the pet. Any means or method for allowing the pet to enter and leave the bag is within the scope of the present invention.

Several descriptions and illustrations have been presented to allow understanding of the present invention. One skilled in the art will realize that numerous changes and variations can be made without departing from the spirit of the invention. Each of these changes and variations is within the scope of the present invention.

I claim:

1. An animal washing system comprising:
a permeable mesh bag with front and back including a flat bottom member, a left side panel, right side panel and back panel;
wherein, said bag also has a front panel with top and bottom end attached to said flat bottom member and to said left and right side panels with a portal proximate the top of said front panel adapted to allow a pet's head to protrude outward from said mesh bag; and,
wherein each of said left side panel and said right side panel has an approximately horizontal slit adapted to allow insertion of a human hand into said mesh bag;
a fastener extending along top sides of said left side panel and said right side panel from the front to the back of said bag, wherein said fastener also partially extends into said back panel;
wherein, said permeable mesh bag freely allows water to flow through it;
whereby, an animal can be placed into said mesh bag, washed and then rinsed.

2. The animal washing system of claim 1 further comprising a drawstring at least partially around said portal so that said portal can be adjusted in size.

3. The animal washing system of claim 1 wherein said mesh bag has a mesh size around 3 mm.

4. The animal washing system of claim 1 wherein said fastener is a zipper.

5. The animal washing system of claim 1 wherein said fastener is a drawstring.

6. The animal washing system of claim 1 where the mesh bag is made of a polymer material.

7. The animal washing system of claim 6 wherein the mesh is a hexagon or square mesh.

8. A pet bathing restraint system comprising a closed water-permeable mesh bag adapted to contain a pet with a front portal allowing a pet's head to emerge; said closed bag opening top, side, front or back for allowing a pet to enter and egress; said bag having at least one hand port for washing a pet.

9. The pet bathing restraint system of claim 8 where said mesh bag has a mesh size of around 3 mm.

10. The pet bathing restraint system of claim 8 wherein said mesh bag is a polymer material.

11. The pet bathing restraint system of claim 8 wherein said front portal is adjustable to fit necks of different pets.

12. The pet bathing restraint system of claim 8 wherein said bag has both a front and back opening closable with a drawstring.

13. A method for bathing a pet comprising:
opening a permeable mesh bag with a top and back zipper;
placing said pet on a flat floor in said mesh bag;
causing said pet's head to emerge from a front portal in said mesh bag;
adjusting said front portal to fit said pet's neck;
washing said pet through at least one side port in said mesh bag;
rinsing said pet in said mesh bag with water;
opening said mesh bag with said top and back zipper;
allowing said pet to exit said mesh bag.

14. The method of claim 13 wherein said mesh bag has a mesh size of around 3 mm.

15. The method of claim 13 wherein said adjusting is performed by tightening a drawstring.

16. The method of claim 13 wherein said top and back zipper are one zipper.

17. The method of claim 13 wherein said mesh bag has two side ports, one on each side of said mesh bag.
